(19) United States
(12) Patent Application Publication
(10) Pub. No.: US 2015/0134133 A1
(43) Pub. Date: May 14, 2015

(54) APPARATUS, SERVER AND METHOD FOR MANAGING ENERGY USAGE AND ENERGY VOLUME PER ENERGY CONSUMER

(71) Applicant: ELECTRONICS AND TELECOMMUNICATIONS RESEARCH INSTITUTE, Daejeon (KR)

(72) Inventors: Wan Ki PARK, Daejeon (KR); IL Woo LEE, Daejeon (KR); Mi Kyong HAN, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 14/293,262

(22) Filed: Jun. 2, 2014

(30) Foreign Application Priority Data
Nov. 8, 2013 (KR) 10-2013-0135376

(51) Int. Cl. G05F 1/66; G05B 15/02

(52) U.S. Cl. CPC G05F 1/66; G05B 15/02
USPC 700/286

(57) ABSTRACT

Disclosed is an apparatus for managing energy. The apparatus includes a user recognition unit configured to recognize each of users who use an energy consuming device; an energy usage receiving unit configured to receive energy usage that is consumed by the user; and a communication unit configured to communicate with an energy volume-rate server that manages the energy usage for each of the user. Further, the apparatus includes a controlling unit configured to control the driving of the energy consuming device depending on regulatory guidance the energy consuming device that is received via the communication unit. Furthermore, the regulatory guidance is determined by the energy volume-rate server.

### CROSS-REFERENCE TO RELATED APPLICATION(S)

The present invention claims priority of Korean Patent Application No. 10-2013-0135376, filed on Nov. 8, 2013, which is incorporated herein by reference.

### FIELD OF THE INVENTION

The present invention relates to an energy management, and more particular, to a an apparatus, server and method for managing energy usage and energy volume per energy consumer that are capable of understanding energy usage for each energy consumer report it to each energy consumer and authorizing the use of energy consuming devices based on the energy usage.

### BACKGROUND OF THE INVENTION

In recent, in order to cope with global environment changes and drain of energy, there has been suggested a system that minimizes energy usage through energy management in homes and buildings. For example, the system may include HEMS (Home Energy Management System) that helps an efficient use of energy in homes and provides features of understanding of energy usage and collecting data about the environment and BEMS (Building Energy Management System) that helps an efficient use of energy in buildings.

However, these systems are difficult to understand the amount of energy usage for each individual consumer. For example, in a case where a number of energy consuming devices exist in buildings and a plurality of energy consumers use these devices, such a building energy management system catches total energy usage used in whole buildings and only imposes a fee for the energy usage to every energy consumer in the buildings evenly, but it cannot notify the consumers their energy usage individually.

Therefore, it is required to understand the energy usage for each individual consumer while ensuring the use of minimal and efficient energy usage. In light of the above, there is a need for a system that is capable of understanding the energy usage for each consumer and notifying the energy consumers with their own energy usage.

### SUMMARY OF THE INVENTION

In view of the above, the present invention provides an apparatus, server and method for managing energy usage for each energy consumer that are capable of understanding the energy usage for each energy consumer to inform the energy consumer of it and giving an regulatory guidance an energy consuming device based on the energy usage.

In accordance with a first aspect the present invention, there is provided an apparatus for managing energy. The apparatus includes: a user recognition unit configured to recognize each of users who use an energy consuming device; an energy usage receiving unit configured to receive energy usage that is consumed by the user who is recognized by the user recognition unit from the energy consuming device; a communication unit configured to communicate with an energy volume-rate server that manages the energy usage for each of the user; and a controlling unit configured to control the driving of the energy consuming device depending on regulatory guidance the energy consuming device that is received via the communication unit, wherein the regulatory guidance is determined by the energy volume-rate server based on the energy usage that is consumed by the user.

Further, the communication unit may transmit and receive one or more of a user profile of the user, the energy usage by the user, or the regulatory guidance the energy consuming device by the user.

Further, the apparatus may further comprise a connection unit configured to connect the energy usage receiving unit with the energy consuming device, and the energy usage receiving unit may receive the energy usage which is consumed by the user who uses the energy consuming device through the connection unit.

Further, the user recognition unit may recognize the user through a user recognition device which is held by the user.

Further, the user recognition unit may comprise any one selected from a group consisting of a device for recognizing an RFID chip, a device that recognizes all or a portion of a body of the user, a device that recognizes a chip embedded in a mobile device held by the user, and a device that receives an identification number inputted by the user.

Further, the controlling unit may be further configured to analyze the regulatory guidance the energy consuming device to control the driving of the energy consuming device depending on the regulatory guidance.

In accordance with a second aspect the present invention, there is provided an energy volume-rate server including: a communication unit configured to communicate with a plurality of the energy consuming devices; and a volume-rate management unit configured to generate an regulatory guidance each energy consuming device by a plurality of users who use the energy consuming device, based on energy usage for each user, and the energy usage may be received through the communication unit.

Further, the communication unit may transmit and receive one or more of a user profile of the user, the energy usage by the user, or the regulatory guidance the energy consuming device by the user.

Further, the volume-rate management unit may comprise: a user profile manager configured to contain user profiles of the plurality of users who use the energy consuming device; an energy volume-rate database that stores energy usage for each user; and an authority generator configured to generate an regulatory guidance the energy consuming device for each user based on the energy volume-rate database.

Further, the energy volume-rate database may comprise: an energy usage database that stores the energy usage for each user; and a mileage database that stores an amount of energy that is available by the user as in a form of a mileage, wherein the authority generator generates the regulatory guidance by each user based on the mileage stored in the mileage database.

Further, the energy volume-rate server may further comprise: an environment-friendly activity administrator configured to transform the record of environment-friendly activities for each user into the mileage, wherein the mileage is accumulated with a previous mileage.

Further, the energy volume-rate server may further comprise: an additional service administrator configured to manage the use of the additional service for each user by subtracting the mileage of the user.

Further, the volume-rate management unit may be further configured to transfer one or more of the energy usage or the regulatory guidance to a mobile device of the user.

Further, the volume-rate management unit may be further configured to transfer one or more of the energy usage, the regulatory guidance, or the mileage to a mobile device of the user.

In accordance with a third aspect the present invention, there is provided a method for managing energy. The method includes recognizing a user who uses an energy consuming device that is utilized by a plurality of users; receiving energy usage that is consumed by the use of the recognized user from the energy consuming device; communicating with an energy volume-rate server that manages the energy usage for each user; and controlling the driving of the energy consuming device based on an regulatory guidance the energy consuming device that is received communicatively.

Further, the regulatory guidance may be determined by the energy volume-rate server based on the energy usage that is consumed by the user.

Further, the communicating with an energy volume-rate server may comprise transmitting and receiving one or more of a user profile of the user, the energy usage by the user, or the regulatory guidance to and from the energy volume-rate server.

With the configuration of the embodiment of the present invention, it is possible to understand the energy usage for each energy consumer so that the energy consumer can be informed of the energy usage and authorize to use an energy consuming device based on the energy usage, thereby deriving efficient and minimal energy usage.

### BRIEF DESCRIPTION OF THE DRAWINGS

The above and other objects and features of the present invention will become apparent from the following description of the embodiments given in conjunction with the accompanying drawings, in which:

FIG. 1 shows a block diagram of a system to which an apparatus and method for managing energy for each energy consumer are applied in accordance with the present invention;

FIG. 2 is a block diagram of an energy management apparatus in accordance with an embodiment of the present invention;

FIG. 3 is a block diagram of an energy volume-rate server in accordance with an embodiment of the present invention;

FIG. 4 is a block diagram of an energy volume-rate database in accordance with an embodiment of the present invention; and

FIG. 5 depicts a sequential diagram of a method for managing energy for each energy consumer in accordance with an embodiment of the present invention.

### DETAILED DESCRIPTION OF THE EMBODIMENTS

Detailed description of the present invention will be described below with reference to the accompanying drawings illustrating specific embodiments of the present invention. These embodiments are described in detail so that those skilled in the art can easily practice the present invention. It should be understood that the various embodiments of the present invention are different from each other, but need not be mutually exclusive. For example, a particular shape, structure and properties that are described herein and are related to one embodiment of the present invention may be implemented with other embodiments without departing the scope of the present invention. Further, it should be understood that the position or arrangement of the individual components in the embodiments may be changed without departing the scope of the present invention. Therefore, a detailed description below is rather than those that try to take as a limiting sense if it is explained properly, the scope of the present invention is only limited by all ranges identical to those that it claims, but the appended claims. Similar reference numerals refer to the same or similar elements throughout the drawings.

Hereinafter, embodiments of the present invention will be described in detail with reference to the accompanying drawings so that they can be readily implemented by those skilled in the art.

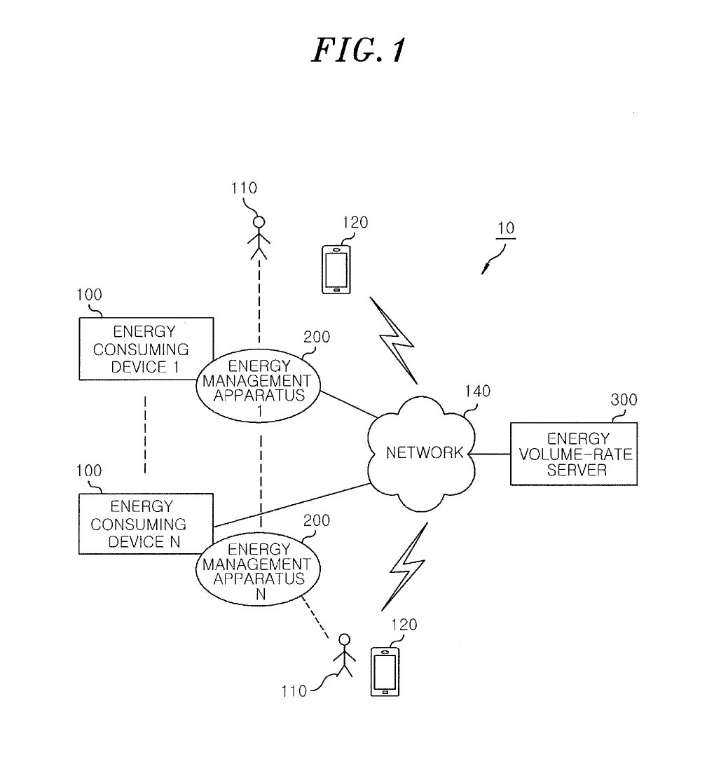

FIG. 1 is a block diagram of a system to which an apparatus and method for managing energy for each user energy consumer are applied in accordance with the present invention. Referring to FIG. 1, a system 10 of the embodiment may include a plurality of energy consuming device 100, a plurality of energy management apparatuses 200 that manages energy consumed by the respective energy consuming devices 100, an energy volume-rate server 300 that is connected with the plurality of the energy management apparatus 200 via a network 140, stores energy usage for each of users the user 110 who utilize the energy consuming devices 100 for the management of the energy usage, and generates a regulatory guidance the respective energy consuming devices 100 to transfer it to the energy management apparatus 200.

In the system 10 of the embodiment shown in FIG. 1, a description will be made on an environment in which a plurality of energy consuming devices 100 exist within a building or a home and a plurality of users 110 utilize the energy consuming devices. However, the embodiment of the present invention is not limited to the environment and may be applied to a situation where a plurality of energy consuming devices is distributed across several buildings. The embodiment may also be applied to another situation where a plurality of users commonly utilizes one energy consuming device 100 existed in a building.

The respective components of the system 10 may be connected via the network 140. For example, the plurality of energy management apparatuses 200 may be connected to the energy volume-rate server 300 via the network 140 and a mobile device for a user 110 who uses the energy consuming devices 100 may be connected to the energy volume-rate server 300 via the network 140.

The network 140 as used herein refers to a physical connection topology capable of exchanging information between the respective nodes such as terminals and servers, which may be the Internet, LAN (Local Area Network), Wireless LAN (Local Area Network), WAN (Wide Area Network), PAN (Personal Area Network), 3G network, 4G network, LTE network, Wi-Fi network, Zigbee, or the like but is not limited thereto.

In this embodiment, the network 140, which connects between the plurality of the energy management apparatuses 200 and the energy volume-rate server 300, may be different from the network 140, which connects between the mobile device 120 and the energy volume-rate server 300. For example, the network 140, which connects between the plurality of the energy management apparatuses 200 and the energy volume-rate server 300, may be a LAN, whereas the network 140, which connects between the mobile device 120 and the energy volume-rate server 300, may be a 3G network. However, the embodiment of the present invention is not limited thereto, and the network 140, which connects between the plurality of the energy management apparatuses 200 and the energy volume-rate server 300, and the network 140, which connects between the mobile device 120 and the energy volume-rate server 300, may be the same as the 3G network.

Each of the energy consuming devices 100 in the embodiment is a device that uses electric energy to do work, e.g., such as lights, electric heater, fan heater, air cooler, air conditioner, etc., and a device that uses water as energy resource, e.g., such as a wash basin, shower, etc., but is not limited thereto and may be any device that consumes any other type of energies.

Each of the energy management apparatuses 200 of the embodiment may recognize a user 110 that uses an energy consuming device 100 and receives energy usage used by the user 110 from the energy consuming device 100.

The energy management apparatus 200 may also transfer a user profile of the user 110 and the energy usage for the user 110 to the energy volume-rate server 300 and obtain a regulatory guidance the energy consuming device 100 from the energy volume-rate server 300. The regulatory guidance the energy consuming device 100 as used herein refers to an authority of use of the energy consuming device 100 that is granted based on the energy usage of the user 110, which will be discussed in detail later.

In the meantime, while the energy management apparatus 200 of the embodiment is connected with the energy consuming device 100, the embodiment is not limited thereto, and it is possible that the energy management apparatus 200 may be, for example, embedded in the energy consuming device 100.

The energy volume-rate server 300 of the embodiment may store the energy usage for each user 110 who use the energy consuming devices for the management thereof and generate a regulatory guidance the energy consuming devices 100 to transmit them to the energy management apparatuses 200. The energy volume-rate server 300 may be implemented by a computer that includes a component to access the network 140 and a database to store data, but not necessarily limited thereto.

Also, the energy volume-rate server 300 may exchange data with the mobile device 120 of the user 110 that uses the energy consuming devices 100 over the network 140. For example, the energy volume-rate server 300 may transmit energy usage used by the mobile device 120 of the user 110, a regulatory guidance the energy consuming device 100, and the like to the energy consuming device 100.

The mobile device 120 as used herein refers to a communication terminal held by the user 110 carried by that serves to report the energy usage by the user 110, the regulatory guidance the energy consuming device 100, and the like to the user 110. For example, the mobile device 120 may be implemented by a handheld-based wireless communication device that ensures portability and mobility, for example, such as a handset for PCS (Personal Communication System), GSM (Global System for Mobile communications), PDC (Personal Digital Cellular), PHS (Personal Handy phone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet), smartphone, smart pad, Tablet PC, or the like.

Hereinafter, the method for managing energy for each user of the embodiment will be described with reference to FIG. 1.

In operation, when the user 110 accesses to use any one of the plurality of the energy consuming devices 100, the energy management apparatus 200 may recognize the user 110. The user profile of the user 110 may then be transferred to the energy volume-rate server 300 from the energy management apparatus 200 over the network 140. The energy volume-rate server 300 may search the database for the energy usage that the user 110 have used until now based on the user profile and may generate a regulatory guidance the energy consuming device 100. The generated availability may be transferred to the energy management apparatus 200 from the energy volume-rate server 300 over the network 140. The energy management apparatus 200 may then run the energy consuming device 100 based on the availability.

The energy usage consumed by the user while using the energy consuming device 100 may be sent to the energy volume-rate server 300 from the energy management apparatus 200 over the network 140. The energy volume-rate server 300 may receive the energy usage and store it in the database.

When accumulated energy usage exceeds a preset upper limit, the energy volume-rate server 300 may generate an instruction to limit the regulatory guidance the energy consuming device 100 and send the instruction to the energy management apparatus 200 over the network 140. The energy management apparatus 200 may analyze the instruction to limit the availability that is received and stop or restrict the use of the energy consuming device 100 by the user 110.

In addition, the energy volume-rate server 300 may send the accumulated energy usage by the user 110, the regulatory guidance, and the like to the mobile device 120.

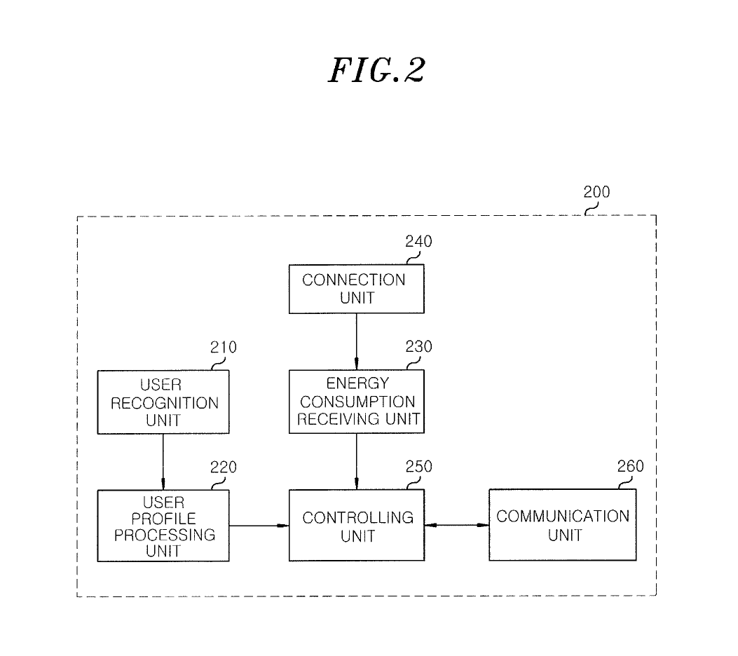

FIG. 2 is a block diagram of the energy management apparatus 200 in accordance with an embodiment of the present invention. Referring to FIG. 2, the energy management apparatus 200 may include a user recognition unit 210 to recognize each of the users 110, a user profile processing unit 220 to analyze the user profile of the user 110 analyzed by the user recognition unit 210, an energy usage receiving unit 230 to receive the energy usage used by the energy consuming device 100, a connection unit 240, a control unit 250 to control the driving of the energy consuming device 100, and a communication unit 260 to transmit and receive the user profile, energy usage, and regulatory guidance the energy consuming device 100 to and from the energy volume-rate server 300.

The user recognition unit 210 may recognize the user 110 through a user recognition device. The user recognition device may include any device that can automatically or manually recognize the user 110, for example, but not limited, a device for recognizing an RFID chip held by the user 110, a device that can recognize all or a portion of a body such as a face, pupil, fingerprint or palm of the user 110, a device that can recognize a USIM chip embedded in the mobile device 120 of the user 110, a device that can receive an identification number inputted by the user, or the like.

The user profile processing unit 220 may process the user profile recognized by the user recognition unit 210 in the form that can be transmitted through the communication unit 260 over the network 140. For example, in a case where the user recognition device is a fingerprint reader, the user profile processing unit 220 may process information on a fingerprint recognized by the finger print reader in the form that can be transmitted over the network 140.

Alternatively, however, the user profile processing unit 220 may be removed from the energy management apparatus 200. In this case, the user recognition unit 210 may undertake responsibility of the user profile processing unit 220, for example, the processing of the information recognized by the user recognition means.

The energy management apparatus 200 may receive the energy usage from the energy consuming device 100 through the energy consuming receiving unit 230. In actual, the energy usage is measured by the energy consuming device 100, and the energy consuming device 200 receives the energy usage from the energy consuming device 100 through the energy consuming receiving unit 230.

Thus the energy management apparatus 200 may be coupled to the energy consuming device 100 through the connection unit 240. In this case, a one end of the connection unit may be coupled to the energy management apparatus 200 and the other end may be coupled to the energy consuming device 100. The other end of the connection unit may have one of various connection ports that are compatible with different energy consuming devices 100.

The controlling unit 250 of the embodiment may control the driving of the energy consuming device depending on the regulatory guidance provided from the energy volume-rate server 300.

In other words, for example, the control unit 250 may analyze the regulatory guidance the energy consuming device 100, which is received through the communication unit 260, and determine whether to allow the driving of the energy consuming device 100. The regulatory guidance as used herein means a regulatory approval of use by which the energy consuming device 100 can be used by the user 100 based on the energy usage of the user. For example, the regulatory guidance may include a regulatory approval of use that can use the energy consuming device 100, a regulatory prohibition of use that cannot use the energy consuming device 100, or a regulatory limitation of use that can limitedly use the energy consuming device 100. The limited use of the energy consuming device may be, for example, but is not limited, the limit of an available maximum output of the energy consuming device 100 that is variable or the limit of use time of the energy consuming device 100.

In addition, the control unit 250 may control the driving of the energy consuming device 100 based on the regulatory guidance. For example, the control unit 250 may switch-on or switch-off a power supply to the energy consuming device 100 or limit the maximum output of the energy consuming device 100.

The communication unit 260 of the embodiment may exchange data between the energy management apparatus 200 and the energy volume-rate server 300. The data as used herein may be, for example, the user profile, amount of energy usage, regulatory guidance, etc., but not limited thereto.

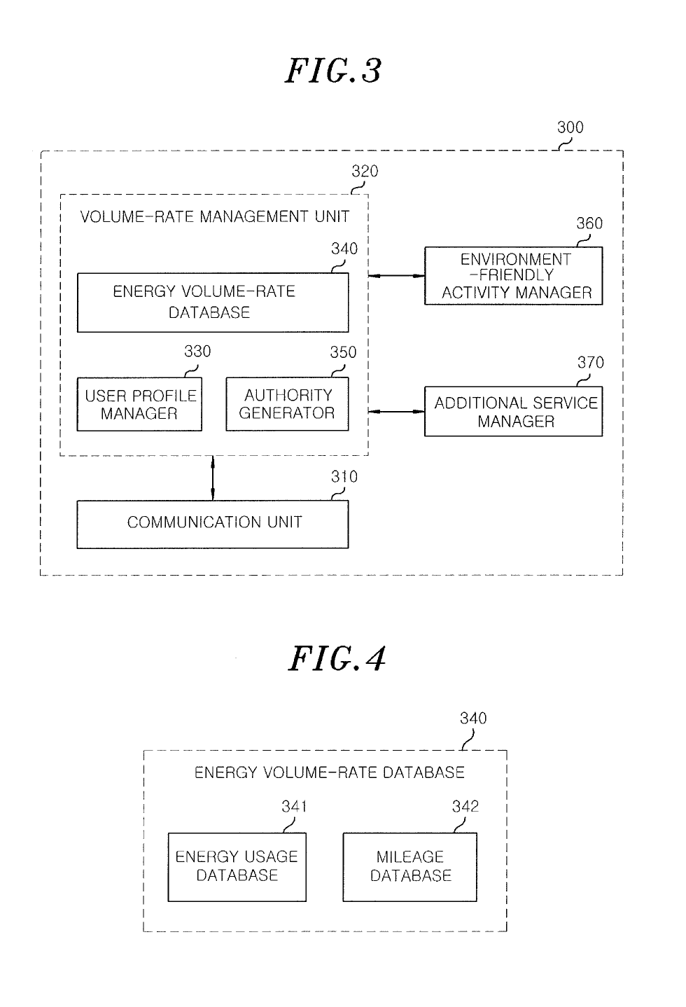

FIG. 3 is a block diagram of the energy volume-rate server 300 in accordance with an embodiment of the present invention. Referring to FIG. 3, the energy volume-rate server 300 may include a communication unit 310 to exchange data with the energy management apparatus 200, and a volume-rate management unit 320 to manage energy usage of the energy consuming device 100 and generate a regulatory guidance the energy consuming device 100 based on the energy usage.

The communication unit 310 may exchange data with the energy management apparatus 200. For example, the communication unit 310 may transfer the energy usage of the user 110, the regulatory guidance the energy consuming device 100, and the like, but is not limited thereto.

In addition, the communication unit 310 may exchange data with the mobile device 120 held by the user 110. For example, the communication unit 310 may transfer the energy usage of the user 110, the regulatory guidance the energy consuming device 100, and the like by means of SMS, etc. to the mobile device 120.

The volume-rate management unit 320 of the embodiment may include a user profile manager 330 to store the user profile of each user 110 for the management thereof, an energy volume-rate database 340 to store the energy usage of each user 110 for the management thereof, and an authority generator 350 to generate the regulatory guidance the energy consuming device 100 based on the data stored in the energy volume-rate database 340.

The user profile manager 330 may store and manage the user profile of the user 110. The user profile as used herein may include personal data of the user 110, information about the mobile device 120 carried by the user 110 and the like.

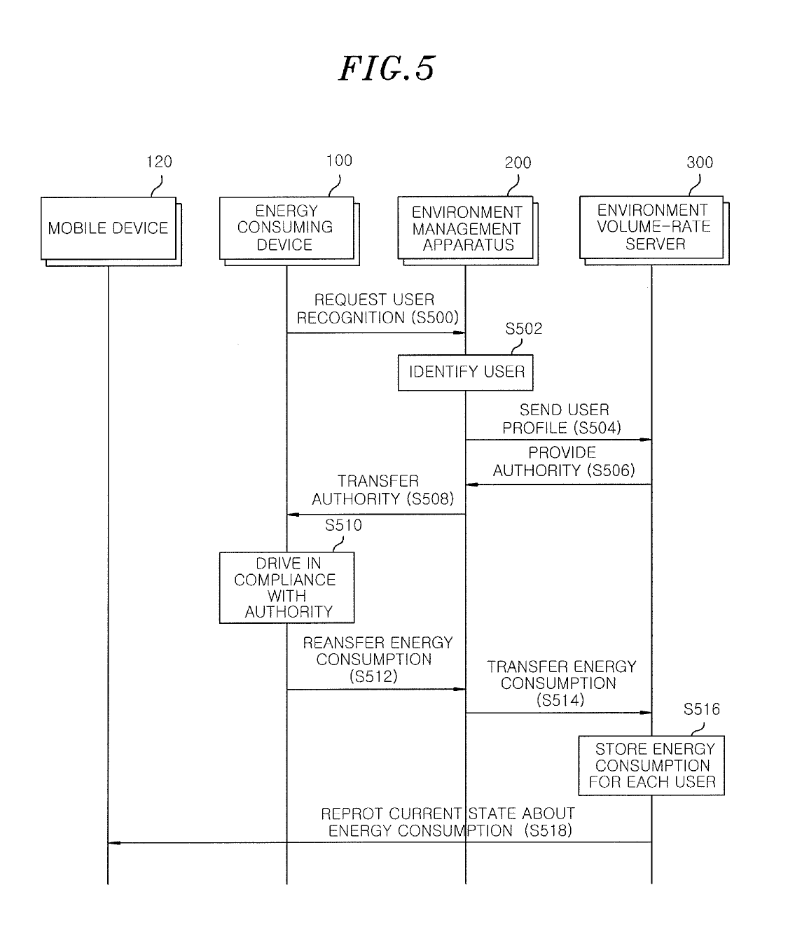

The energy volume-rate database 340 may store and manage data in which the energy usage of the user 110, energy usage that can be used by the user 110, and the like is represented as a mileage. The energy volume-rate database 340 may have a form of database, of which detailed description will be made with reference to FIG. 4 below.

FIG. 4 is a block diagram of the energy volume-rate database 340 in accordance with an embodiment of the present invention. Referring to FIG. 4, the energy volume-rate database 340 may include an energy usage database 341 to store the energy usage of each user 110. The energy usage may be stored for each user and updated for each user.

The energy usage database 341 may store a total amount of energy and the consumption of energy. The total amount of energy means an entire amount of energy that can be used by the user 110. In the embodiment, the total amount of energy may be equal to or different from every user 110.

The consumption of energy means an amount of energy usage that is used by the user 110. The consumption of energy may be updated in real time or periodically. For example, the consumption of energy may be updated shortly after the user 110 consumes energy by receiving the energy usage over the network 140, or may be updated by receiving the energy usage over the network 140 at predefined time intervals.

As such, the updated consumption of energy may be employed to generate the regulatory guidance the energy consuming device 100 by the user 110.

The energy volume-rate database 340 of the embodiment may further include a mileage database 342 to store an amount of energy that is available by the user 110 as a mileage.

The mileage as used herein may be calculated based on the energy usage. For example, the mileage may be calculated by subtracting the energy usage from the total amount of energy that is stored in the energy usage database 341.

Further, the mileage may be increased or decreased under a special condition. For example, when the user 110 does an environment-friendly activity, the mileage may increase by transforming the record of the environment-friendly activity into a mileage to accumulate it. On the contrary, when the user 110 uses an additional service with the mileage, the mileage may decrease. The increase or decrease of the mileage will be described later depending on the specific condition of the mileage.

As mentioned above, since the amount of energy that can be used by the user 110 may not be determined by only the amount of energy that is used by the user 110, the mileage database 342 may be separately arranged from the energy usage database 341.

Though the energy volume-rate database 340 in this embodiment includes both of the energy usage database 341 and the mileage database the mileage database 342, the mileage database 342 may be removed from the energy volume-rate database 340 in another embodiment.

Referring back to FIG. 3, an authority generator 350 of the embodiment may generate the regulatory guidance the energy consuming device 100 by the user 110. The regulatory guidance as used herein may be generated based on the mileage of each user 110. For example, the regulatory guidance may be granted when the mileage of the user 110 who wants to use the energy consuming device 100 is above a preset value. However, when the mileage is below a preset value, the regulatory guidance may not be granted at all, or the regulatory guidance may be given but is limited in using the maximum output of the energy consuming device 100.

The authority generator 350 may update the regulatory guidance during the user 110 uses the energy consuming device 100. The update of the regulatory guidance may be the withdrawal of regulatory guidance or the limit of the maximum output of the energy consuming device while maintaining regulatory guidance. For example, the regulatory guidance the mileage may be withdrawn if the mileage is below a preset value when the mileage database 342 is updated with the usage of the energy consuming device 100.

The updated regulatory guidance may be transferred to the energy management apparatus 200 through the communication unit 310, and the energy management apparatus 200 may control the driving of the energy consuming device 100 in accordance with the regulatory guidance.

Meanwhile, the energy volume-rate server 300 may further include an environment-friendly activity administrator 360 that transforms the record of the environment-friendly activities of the user 110 into a mileage so that the transformed mileage can be accumulated to a previous mileage of the user 110 that is previously stored in the mileage database 342.

The environment-friendly activity administrator 360 may receive the record of the environment-friendly activities of the user 110 and then transform the record into the mileage, which will be forwarded to the mileage database 342. The environment-friendly activity as used herein means an activity associated with an energy saving. For example, the environment-friendly activity may include activities to refrain from using disposable products such as using individual cups or the like instead of using paper cups.

The record of the environment-friendly activities is transformed into a mileage which is in turn forwarded to the mileage database 342 where the mileage is accumulated to the previous mileage of the user 110. Therefore, an available amount of energy of the user may be increased, whereby it is possible to motivate the environment-friendly activity of the user.

The authority generator 320 may further include the additional service administrator 370 which manages the use of the additional service by subtracting the mileage of the user 110. The user 110 may receive the additional service with the mileage, and the fee of the additional service will be deducted from the mileage.

The additional service as used herein refers to any kind of services that can be provided for payment of money, points, or the like. For example, the additional service may include a service that provides discount as much as a mileage when the user purchases goods, a service that provides saving the charge of delivery by using the mileage when using a delivery service, or the like.

FIG. 5 depicts a sequential diagram of a method of managing energy for each energy consumer in accordance with an embodiment of the present invention. Hereinafter, the method of the embodiment will be described with reference to FIGS. 1 to 5.

First, when the user 110 wants to use the energy consuming device 100 in a building or home at which the user resides, the user may make a request for user recognition through information for various recognition such as an RFID chip, face recognition, pupil recognition, fingerprint recognition.

Once the user recognition is requested from the user, the energy consuming device 100 requests the user identification by sending the user recognition information to the energy management apparatus 200 (Block S500).

Next, in response to the request for the user recognition, the energy management apparatus 200 performs the user identification using the user recognition information (Block S502).

For the user identification, the energy management apparatus 200 may perform the user identification using an RFID reader to recognize the RFID chip or a recognition device to recognize a face, pupil, fingerprint, or the like of the user 110.

After the user identification, the energy management apparatus 200 transfers the user profile to the energy volume-rate server 300 (Block S504).

The energy volume-rate server 300, which manages the energy usage of the user, generates an regulatory guidance the energy consuming device 100 of the user, which will then be provided to the energy management apparatus 200 (Block S506).

In this connection, the energy volume-rate server 300 recognizes the energy usage for the user 110 based on the energy volume-rate database 340, which stores the energy usage for each user, and generates the regulatory guidance the energy consuming device 100 based on the energy usage of the relevant user 110. For example, the energy volume-rate server 300 may issue a limited regulatory guidance the energy consuming device in a case where the energy usage of the user until now approaches a total amount of energy usage of the user as a result of comparing them. Meanwhile, in a case where the energy usage of the user is below a preset upper limit as a result of the comparison, thus there remains a plenty amount of energy from the total amount of energy, the energy volume-rate server 300 may issue an authority to plentifully use the energy consuming device 100.

As such, upon receiving the regulatory guidance the energy consuming device 100 from the energy volume-rate server 300, the energy management apparatus 200 transfers the regulatory guidance the energy consuming device 100 (Block S508).

Accordingly, the energy consuming device 100 allows the user 110 to utilize the energy consuming device 100, whereas the energy consuming device 100 may drive operations in compliance with the limited regulatory guidance when receiving the limited regulatory guidance (Block S510).

Subsequently, when the user 110 terminates the use of the energy consuming device, the energy consuming device 100 calculates energy usage of the energy consuming device 100 by the user 110 and sends the calculated energy usage to the energy management apparatus 200. (Block S512).

The energy management apparatus 200 transmits the calculated energy usage of the energy consuming device 100 by the user 110 to the energy volume-rate server 300 (Block S514). The energy volume-rate server 300 stores the energy usage by the user 110 by accumulating it in the energy volume-rate database 340 and manages the accumulated energy usage of the user (Block S516).

After that, the energy volume-rate server 300 examines current state information about the energy usage by the user and reports the current state information to the mobile device 120 (Block S518), whereby the user 110 understands the current state of the energy usage of himself/herself.

The embodiments of the present invention as described above may be implemented in the form of program instructions that are executable by various computer components and recorded in a computer readable media. The computer readable media may be may contain program instructions, data files, data structures, etc. individually or in the form of a combination thereof The program instructions recorded on the computer readable media may be ones that are specially designed or organized for the purpose of the embodiments or ones that are useable to those skilled in the software art available. Further, the computer readable media may include, for example, hard disk drives, magnetic media such as floppy disk drivers and magnetic tapes, optical media such as CD-ROMs, DVDs, or the like, magneto-optical media such as floptical disks, dedicated hardware devices such as ROMs, RAMs and flash memories that are specifically configured to store and execute the program instructions. Examples of the program instructions include machine codes that are converted by a complier and high-level language codes executable by a computer using an interpreter. The hardware devices may be organized to operate as one or more software modules to process the embodiments described herein, and the reverse case is similar.

While the present invention has been shown and described with reference to specific matters such as the concrete elements and the definitive embodiments and drawings, it should be noted by those skilled in the art that these are provided only for the general understanding of the present invention. Therefore, the present invention may not be limited to the foregoing embodiments and may be changed and modified in various forms from the above description.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for managing energy, the apparatus comprising:
a user recognition unit configured to recognize each of users who use an energy consuming device;
an energy usage receiving unit configured to receive energy usage that is consumed by the user who is recognized by the user recognition unit from the energy consuming device;
a communication unit configured to communicate with an energy volume-rate server that manages the energy usage for each of the user; and
a controlling unit configured to control the driving of the energy consuming device depending on regulatory guidance the energy consuming device that is received via the communication unit,
wherein the regulatory guidance is determined by the energy volume-rate server based on the energy usage that is consumed by the user.

2. The apparatus of claim 1, wherein the communication unit transmits and receives one or more of a user profile of the user, the energy usage by the user, or the regulatory guidance the energy consuming device by the user.

3. The apparatus of claim 1, further comprising:
a connection unit configured to connect the energy usage receiving unit with the energy consuming device,
wherein the energy usage receiving unit receives the energy usage which is consumed by the user who uses the energy consuming device through the connection unit.

4. The apparatus of claim 1, wherein the user recognition unit recognizes the user through a user recognition device which is held by the user.

5. The apparatus of claim 4, wherein the user recognition unit comprises any one selected from a group consisting of a device for recognizing an RFID chip, a device that recognizes all or a portion of a body of the user, a device that recognizes a chip embedded in a mobile device held by the user, and a device that receives an identification number inputted by the user.

6. The apparatus of claim 1, wherein the controlling unit is further configured to analyze the regulatory guidance the energy consuming device to control the driving of the energy consuming device depending on the regulatory guidance.

7. An energy volume-rate server comprising:
a communication unit configured to communicate with a plurality of the energy consuming devices; and
a volume-rate management unit configured to generate an regulatory guidance each energy consuming device by a plurality of users who use the energy consuming device, based on energy usage for each user,
wherein the energy usage is received through the communication unit.

8. The energy volume-rate server of claim 7, wherein the communication unit transmits and receives one or more of a user profile of the user, the energy usage by the user, or the regulatory guidance the energy consuming device by the user.

9. The energy volume-rate server of claim 7, wherein the volume-rate management unit comprises:
a user profile manager configured to contain user profiles of the plurality of users who use the energy consuming device;
an energy volume-rate database that stores energy usage for each user; and
an authority generator configured to generate an regulatory guidance the energy consuming device for each user based on the energy volume-rate database.

10. The energy volume-rate server of claim 9, wherein the energy volume-rate database comprises:
an energy usage database that stores the energy usage for each user; and
a mileage database that stores an amount of energy that is available by the user as in a form of a mileage, wherein the authority generator generates the regulatory guidance by each user based on the mileage stored in the mileage database.

11. The energy volume-rate server of claim 10, wherein the energy volume-rate server further comprises:
an environment-friendly activity administrator configured to transform the record of environment-friendly activities for each user into the mileage, wherein the mileage is accumulated with a previous mileage.

12. The energy volume-rate server of claim 10, wherein the energy volume-rate server further comprises:
an additional service administrator configured to manage the use of the additional service for each user by subtracting the mileage of the user.

13. The energy volume-rate server of claim 7, wherein the volume-rate management unit is further configured to transfer one or more of the energy usage or the regulatory guidance to a mobile device of the user.

14. The energy volume-rate server of claim 9, wherein the volume-rate management unit is further configured to transfer one or more of the energy usage, the regulatory guidance, or the mileage to a mobile device of the user.

15. A method for managing energy, the method comprising:
recognizing a user who uses an energy consuming device that is utilized by a plurality of users;
receiving energy usage that is consumed by the use of the recognized user from the energy consuming device;
communicating with an energy volume-rate server that manages the energy usage for each user; and
controlling the driving of the energy consuming device based on an regulatory guidance the energy consuming device that is received communicatively.

16. The method of claim 15, wherein the regulatory guidance is determined by the energy volume-rate server based on the energy usage that is consumed by the user.

17. The method of claim 15, wherein said communicating with an energy volume-rate server comprises:
transmitting and receiving one or more of a user profile of the user, the energy usage by the user, or the regulatory guidance to and from the energy volume-rate server.
